(19) United States
(12) Patent Application Publication
(10) Pub. No.: US 2007/0131089 A1
(43) Pub. Date: Jun. 14, 2007

(54) Support for musical instrument

(76) Inventor: Wu-Hong Hsieh, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/298,461

(22) Filed: Dec. 12, 2005

(51) Int. Cl. G10D 13/02

(52) U.S. Cl. 84/422.3

(57) ABSTRACT

A support for a musical instrument has an outer tube and an inner tube substantially inserted into the outer tube. A neck, which has two first skewed surfaces and petals, is mounted at a connecting portion of the inner and the outer tube. A collar, which has two second skewed surfaces corresponding to the first skewed surfaces, is mounted around the neck. When the outer collar is rotated relative to the neck in different directions, the petals can press on or release the inner tube so that the inner tube can be easily adjusted relative to the outer tube to adjust the height of a musical instrument mounted on the support.

### BACKGROUND OF THE INVENTION

1. Field of the Invention

The present invention relates to a support for a musical instrument, and more particularly to a support with which it is easy to adjust the height of the musical instrument.

2. Description of the Related Art

A conventional support for a musical instrument allows a musical instrument to be positioned in a desired position and at a desired height for a performer to play.

With reference to FIG. 7, a conventional support comprises an outer tube (61), an inner tube (62), and a locking device (not numbered). The outer tube (61) has outer threads (611) formed on an outer wall. A stabilizing plug (63) is provided at a lower end of the inner tube (62). The locking device has a hollow neck (64) and a collar (65). The neck (64) has a compression ring (66) with separate petals (not numbered) formed in a top end thereof. The collar (65) has inner threads (651) formed on an inner wall corresponding to the outer threads (611) of the outer tube (61), and a tapered end (652) formed in a top end thereof.

The lower end of the inner tube (62) with the stabilizing plug (63) is inserted into the outer tube (61). The neck (64) is mounted at a top end of the outer tube (61) between the outer tube (61) and the inner tube (62). The collar (65) is sleeved around the junction of the inner tube (62) and the outer tube (61). The tapered end (652) pushes the petals of the compression ring (66) inwards to abut the inner tube (62) and securely hold the inner tube (62) in position.

The collar (65) can be loosened to adjust the position of the inner tube (62) to a desired height and then retightened to maintain the position.

However, the collar (65) must be rotated several times to loosen and tighten it around the outer tube (61) in order to adjust the height of the conventional support for a musical instrument, which is inconvenient. In addition, at times the collar (65) cannot be tightened around the compression ring (66) enough to maintain sufficient pressure on the inner tube (62) to keep it in position, especially under heavy loads.

Therefore, the invention provides a support for a musical instrument to mitigate or obviate the aforementioned problems.

### SUMMARY OF THE INVENTION

The main objective of the present invention is to provide a support for a support for a musical instrument with which it is easy to adjust the height of the musical instrument.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a support for a musical instrument in accordance with the present invention;

FIG. 2 is an exploded perspective view of the support for a musical instrument in FIG. 1;

FIG. 3 is an enlarged side view in partial section of the support for a musical instrument in FIG. 1;

FIG. 4 is an enlarged operational side view in partial section of the support for a musical instrument in FIG. 1;

FIG. 5 is an enlarged operational side view in partial section of the support for a musical instrument in FIG. 1;

FIG. 6 is an operational perspective view of the support for a musical instrument in FIG. 1; and

FIG. 7 is a perspective view in partial section of a conventional support for a musical instrument.

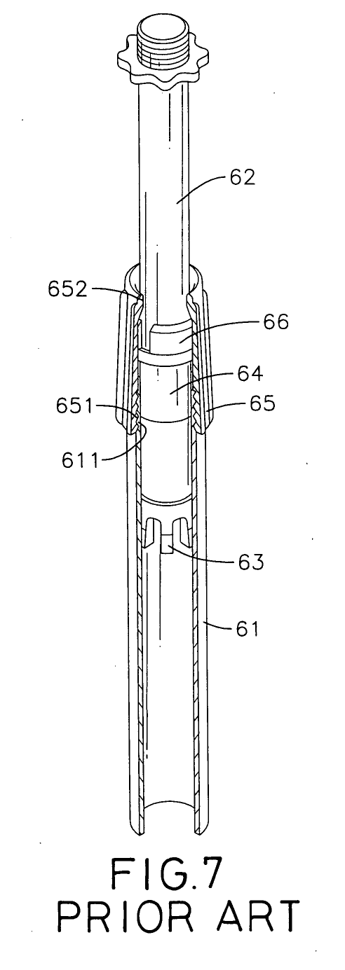

### DETAILED DESCRIPTION OF THE PREFERRED EMBODIMENT

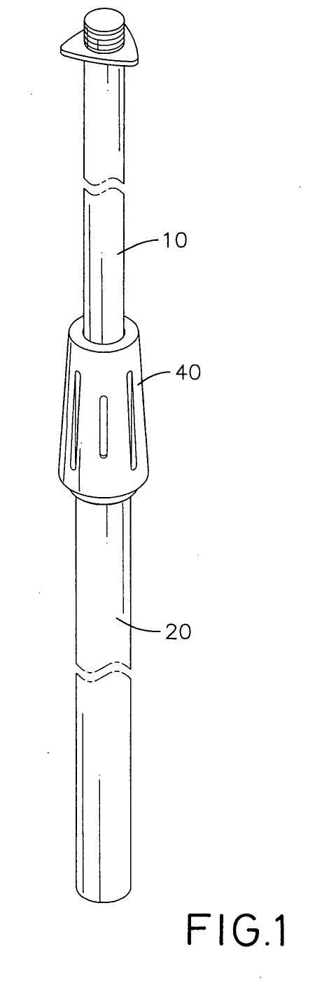

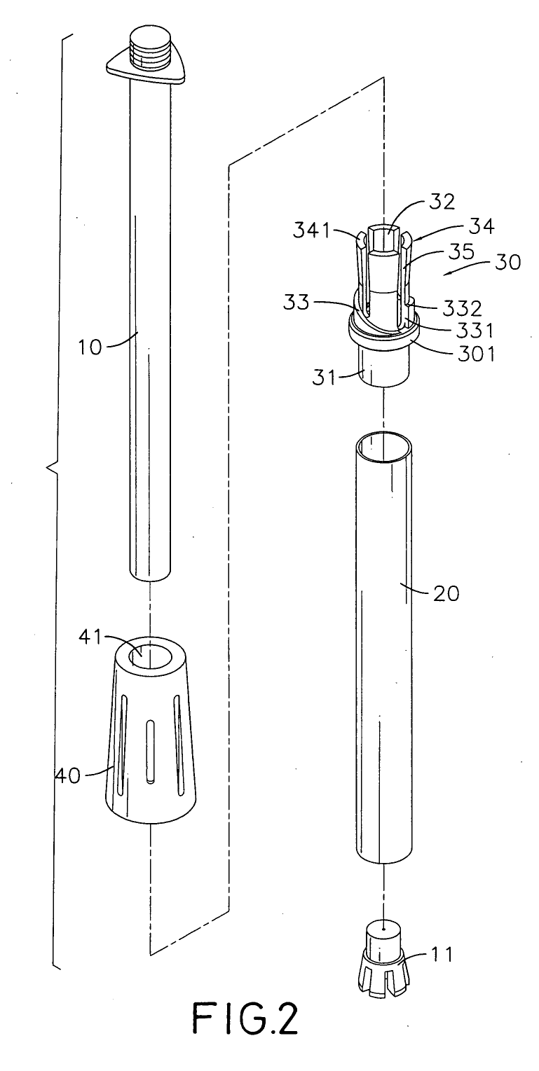

With reference to FIGS. 1 and 2, a support for a musical instrument has an inner tube (10), an outer tube (20), a neck (30), a collar (40), and a stabilizing plug (11).

The neck (30) has a through hole (32) defined in a center thereof, a flange (301) formed in a middle portion thereof and a seat (31) formed in a lower end thereof. The outer diameter of the seat (31) is slightly smaller than that of the flange (301). Two first skewed surfaces (33) are respectively formed on an upper outer edge of the flange (301) and opposite to each other. Each first skewed surface (33) has a connecting sidewall (331) and a locking sidewall (332) adjacent to the connecting sidewall (331).

Four petals (34), each of which has a free end (341) are formed on an upper inner edge of the flange (301) and extend upward. Four gaps (35) are evenly defined respectively between the petals (34).

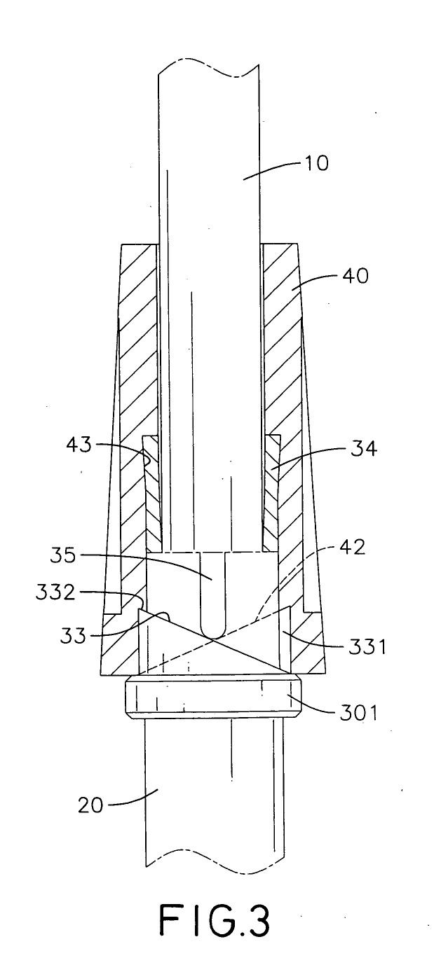

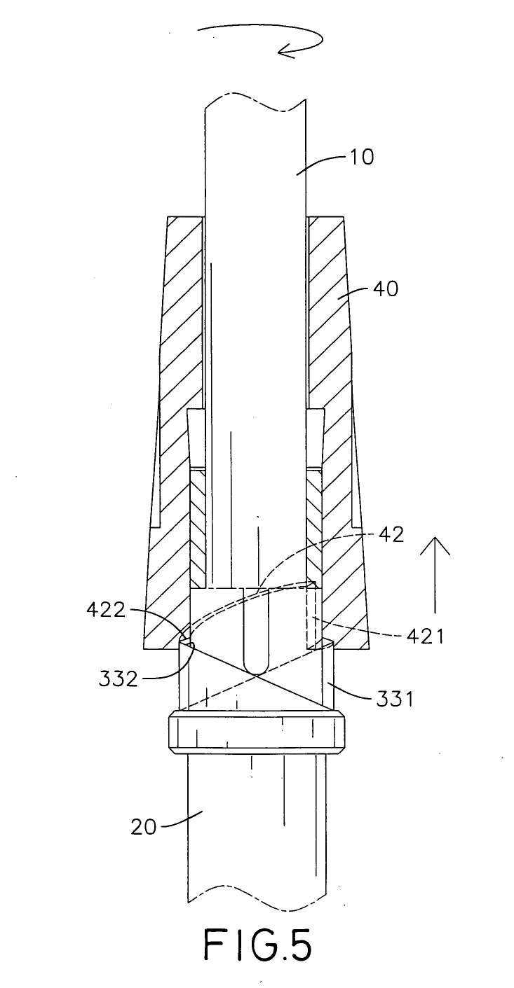

With further reference to FIGS. 3 and 5, the collar (40) has a through opening (41) defined in a top center thereof and a chamber (43) defined in a middle portion thereof. Two second skewed surfaces (42) are respectively formed in an inner surface at the bottom of the collar (40) and each has a second connecting sidewall (421) and a second locking sidewall (422) adjacent to the second connecting sidewall (421). Each second connecting sidewall (421) corresponds to a first connecting sidewall (331) and each second positioning sidewall (422) corresponds to a first positioning sidewall (332) on the neck (30).

The neck (30) is substantially inserted into and mounted at an end of the outer tube (20). The collar (40) is provided around the neck (30) so that the petals (34) are respectively received in the chamber (43). The inner tube (10) is inserted into the the through opening (41) of the collar (40), the through hole (32) of the neck (30), and into the outer tube (20) so that inner sidewalls of the petals (34) abut an outer sidewall of the inner tube (10). The stabilizing plug (11) is substantially inserted into a lower end of the inner tube (10) opposite the neck (30), and an outer edge of the stabilizing plug (11) abuts an inner sidewall of the outer tube (20).

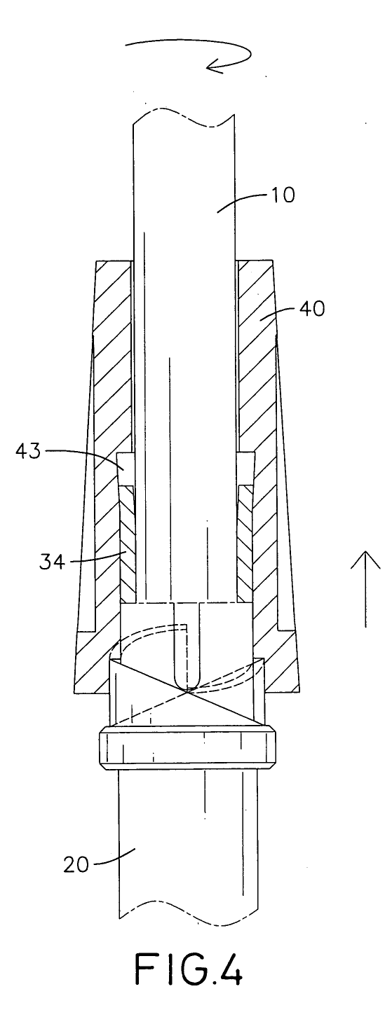

With further reference to FIG. 4, the collar (40) is rotated relative to the neck (30) in a first direction so that the second skewed surfaces (42) move respectively along the first skewed surfaces (33). When the second positioning sidewalls (422) abut the first positioning sidewalls (332), the free ends (341) of the petals (34) are evenly pressed by an inner sidewall of the chamber (43) causing the inner sidewall of the petals (34) to abut the outer sidewall of the inner tube (10). Hence, the inner tube (10) is held securely in position in the outer tube (20).

With further reference to FIG. 5, when the collar (40) is rotated relative to the neck (30) in a second direction, the second connecting sidewalls (331) abut the first connecting sidewalls (421) and the outer sidewall of the inner tube (10) is released by the inner sidewall of the petals (34). The inner tube (10) can then be adjusted relative to the outer tube (20) to a desired height.

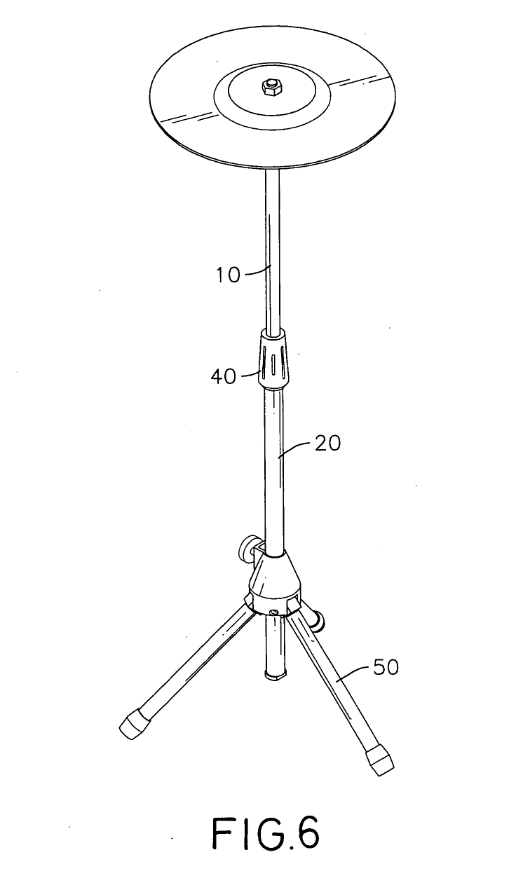

With reference to FIG. 6, multiple legs (50) are respectively mounted at a lower end of the outer tube (20) and a musical instrument is mounted on an upper end of the inner tube (10). The height of the musical instrument can be easily adjusted without having to turn the collar (40) multiple times.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A support for a musical instrument comprising:
an inner tube;
an outer tube;
an neck mounted at an end of the outer tube and having
a through hole defined in a center thereof,
a flange formed around a middle portion of the neck,
two first skewed surfaces formed on an upper outer edge of the flange and opposite to each other,
at least two petals evenly and longitudinally formed adjacent to the first skewed surfaces each having
a free end,
at least two gaps defined between adjacent petals; and a collar mounted around the neck and having
a through opening defined in a top center thereof,
a chamber defined in a middle portion thereof wherein the petals are received into the chamber,
two second skewed surfaces formed in an inner sidewall thereof and corresponding to the first skewed surfaces;
wherein the inner tube is inserted into the neck and the collar and received substantially into the outer tube.

2. The support for a musical instrument as claimed in claim 1, wherein each first skewed surface has a first connecting sidewall and a first positioning sidewall adjacent to the connecting sidewall, and each second skewed surface has a second connecting sidewall and a second positioning sidewall, each second connecting sidewall corresponding to one of the first connecting sidewalls and each second positioning sidewall corresponds to one of the first positioning sidewalls.

3. The support for a musical instrument as claimed in claim 2, wherein a stabilizing plug is provided in an end of the inner tube and an end of the stabilizing plug abuts an inner sidewall of the outer tube.
